(19) United States
(12) Patent Application Publication
(10) Pub. No.: US 2024/0159961 A1
(43) Pub. Date: May 16, 2024

(54) METHOD FOR MANUFACTURING A PHOTONIC DEVICE PROVIDED WITH AT LEAST TWO PHOTONIC CHIPS, AND PHOTONIC DEVICE

(71) Applicant: Scintil Photonics, Grenoble Cedex 9 (FR)

(72) Inventor: Sylvie Menezo, Grenoble Cedex9 (FR)

(21) Appl. No.: 18/552,255

(22) PCT Filed: Mar. 23, 2022
(86) PCT No.: PCT/FR22/50538

§ 371 Date: Sep. 25, 2023

(30) Foreign Application Priority Data
Apr. 7, 2021 (FR) FR2103538

(51) Int. Cl. G02B 6/12; G02B 6/13; G02B 6/136

(52) U.S. Cl. CPC G02B 6/12004; G02B 6/131; G02B 6/136; G02B 2006/12085; G02B 2006/12121; G02B 2006/12123; G02B 2006/12147; G02B 2006/12176; G02B 2006/12178

(57) ABSTRACT

A method of manufacturing a device comprises the following steps: a) providing a structure that comprises a layer on a final substrate, the layer comprising a first guide and a second guide, and a grating coupler, the first and second waveguides being spaced apart from a coupling face by a first distance D1 and a second distance D2, greater than D1, respectively; b) transferring, to the coupling face, at least one first block and at least one second block formed of a first and of a second photonic stack, respectively; c) forming, from the first block and from the second block, respectively, a first component and a second component coupled, respectively, to the first waveguide evanescently or adiabatically, and to the second waveguide via the grating.

### CROSS REFERENCE TO RELATED APPLICATIONS

This application is a national phase entry under 35 U.S.C. § 371 of International Patent Application PCT/FR2022/050538, filed Mar. 23, 2022, designating the United States of America and published as International Patent Publication WO 2022/214748 A1 on Oct. 13, 2022, which claims the benefit under Article 8 of the Patent Cooperation Treaty to French Patent Application Serial No. FR2103538, filed Apr. 7, 2021.

### TECHNICAL FIELD

The field of the present disclosure is that of integrated photonic components. More particularly, the present disclosure relates to the issue of optical coupling of photonic components within a photonic device. In particular, the present disclosure proposes a method for co-integrating and optically coupling a plurality of photonic components on a device. In particular, the present disclosure proposes a method making it possible to integrate two photonic components into a device according to two different modes of coupling.

### BACKGROUND

Co-integration of photonic components with microelectronic devices has grown considerably over the last two decades, in particular to meet new needs of the fields of communications and quantum optics.

Indeed, these photonic components, which are generally made of III-V semiconductor materials, the performance of which no longer needs demonstrating, can be directly integrated on silicon substrates or supports supporting microelectronic devices to form monolithic devices. In particular, their integration implements proven techniques of the microelectronics industry such as steps of bonding, polishing and even etching.

Communication between photonic components and microelectronic components of the same device, however, requires the formation of optical coupling means and/or guiding means for light radiation capable of being emitted or received by the photonic components.

In this respect, different types of optical couplings, depending on the targeted applications or the nature of the photonic components, can be considered. Among the latter, mention may be made of surface coupling, coupling by evanescent or adiabatic waves, and finally butt coupling.

Thus, FIG. 1, showing FIG. 2 of the document [1] cited at the end of the description, is an illustration of a surface coupling (called a “bottom” coupling) between a silicon waveguide GO1 with a photodetector PD1 made of III-V semiconductor materials.

In particular, in this FIG. 1, the waveguide GO1, encapsulated in an encapsulation layer CE1 (made of “BCB” resin), is terminated, according to one of its ends, by a grating coupler RC1.

The photodetector PD1 rests, by a photosensitive face, on the encapsulation layer and in line with the grating coupler RC1. Such an arrangement allows radiation guided by the waveguide GO1, when it reaches the grating coupler RC1, to be transmitted to the photodetector PD1 by its photosensitive face (or more generally “its coupling face”). Such a coupling mode makes it possible to consider media with different indices. More particularly, the grating coupler RC1 and the coupling face of photodetector PD1 may be made of materials of different indices.

The document [2], cited the end of the description, proposes a photonic device provided with an avalanche photodiode (“APD”), optically coupled by evanescent or adiabatic waves with a waveguide made of silicon (FIG. 2, which reproduces FIG. 2(a) of the document [2]). To this end, the avalanche photodiode is arranged plumb with and near the waveguide so as to allow effective coupling.

Finally, and as described in the document [3] cited at the end of the description, butt coupling implements a coupling on one side or a lateral surface SL3 of the photonic component PD3 in question. In particular, as shown in FIG. 3 (FIG. 2(a) from the document [3]), the photonic component PD3 is configured to receive light radiation, guided by a waveguide G03.

The document [5] cited at the end of the description discloses a method for designing an adiabatic transformer between two waveguides.

The document [6] cited at the end of the description proposes the implementation of an optical coupling by means of a grating coupler between a waveguide and a sensor.

Each of the couplings described above is thus implemented to meet a specific feature of the photonic component, more particularly a specificity relating to its shape and/or function. Thus, the consideration of the integration of different types of photonic components may involve different optical coupling modes from one component to another.

However, each coupling mode meets very precise criteria. In particular, a surface coupling generally requires a minimum distance, of at least 200 nm, between the grating coupler and the photonic component in order to avoid coupling by evanescent or adiabatic waves. Furthermore, the coupling face generally has a non-zero reflection coefficient, which is likely to limit the efficiency of the coupling between the waveguide and the photonic component. Indeed, radiation from the waveguide and coupled to the photonic component via the grating coupler is likely to be at least partially reflected by the coupling face and be reinjected into the waveguide.

For its part, coupling by evanescent or adiabatic waves requires proximity, and in particular a distance less than or equal to 150 nm, between the photonic component and the waveguide with which it is optically coupled. Moreover, this coupling also implies that the refractive indices of the materials forming the waveguide and the photonic component are close.

In other words, the consideration of surface coupling and evanescent or adiabatic wave coupling within a photonic device for two different photonic components makes the method for manufacturing the device more complicated. In particular, this added complexity is characterized by an increased number of steps of forming and/or transferring components.

One aim of the present disclosure is therefore to propose a method for manufacturing a photonic device that implements evanescent or adiabatic wave coupling and surface coupling with, respectively, a first photonic component and a second photonic component.

Another aim of the present disclosure is also to propose a method for improving surface coupling.

### BRIEF SUMMARY

The aims of the present disclosure are, at least in part, achieved by a method for manufacturing a photonic device that comprises the following successive steps:
a) a step of providing a support structure that comprises a coupling layer provided with a coupling face and an assembly face, opposite the coupling face, the coupling layer resting, by its assembly face, on a main face of a final substrate, the coupling layer comprising at least one first waveguide and at least one second waveguide, terminated on one of its ends by a first grating coupler, the first waveguide comprising a monocrystalline material, the first and the second waveguide being remote from the coupling face, respectively, a first distance D1 and a second distance D2, greater than the first distance D1, advantageously the first distance D1 is less than 150 nm and the second distance D2 is greater than 200 nm, the provision of the support structure comprising the formation of the coupling layer from a semiconductor-on-insulator substrate, then the transfer of the coupling layer onto the main face of the final substrate;
b) a step of transferring, on the coupling face, at least a first and at least one second block made, respectively, of a first and of a second photonic stack;
c) a step of forming from the first block and from the second block, respectively, a first and a second photonic component optically coupled, respectively, with the at least one first waveguide evanescently or adiabatically, and with the at least one second waveguide via the first grating coupler.

According to one embodiment, the semiconductor-on-insulator substrate comprises, from a rear face toward a front face, an initial substrate, a buried oxide layer and a semiconductor layer, the buried oxide layer forming part of the coupling layer, and advantageously having a thickness equal to the first distance D1.

According to one embodiment, the formation of the coupling layer comprises a sub-step a1) of partial etching of the semiconductor layer so as to form the at least one first waveguide.

According to one embodiment, the formation of the coupling layer comprises a sub-step a2) of forming a first sheath layer, advantageously made of silicon dioxide, overlapping the front face of the semiconductor-on-insulator substrate and intended to encapsulate the first waveguide.

According to one embodiment, the formation of the coupling layer comprises a sub-step a3) of forming the second waveguide and the first grating coupler on the first sheath layer, advantageously the thickness of the first sheath layer is adjusted so that the second waveguide and the first grating coupler are at a distance from an interface, formed between the initial substrate and the buried oxide layer, equal to the second distance D2.

According to one embodiment, the formation of the coupling layer comprises a sub-step a4) of forming a second sheath layer, advantageously made of silicon dioxide, overlapping the first sheath layer and intended to encapsulate the second waveguide and the first grating coupler.

According to one embodiment, the transfer of the coupling layer comprises the assembly of the assembly face and of the main face of the final substrate, and then the removal of the initial substrate so as to transfer the coupling layer onto the main face, the removal of the initial substrate advantageously comprises a mechanical thinning.

According to one embodiment, the step b) comprises the following sub-steps:
b11) a step of forming, by epitaxy, the first photonic stack on one face, called the seed face, of a first seed substrate;
b12) a cutting step to form first sections that each comprise a first portion of the first seed substrate on which a first piece formed of the first photonic stack rests;
b13) a step of assembling the first pieces on the coupling face;
b14) a step of removing the first portion at the end of step c13) so as to transfer the first piece onto the coupling face.

In an equivalent manner, the formation of the second stack on the coupling face may comprise the following steps:
c21) a step of forming, by epitaxy, the second photonic stack on one face, called the seed face, of a second seed substrate;
c22) a cutting step to form second sections that each comprise a second portion of the second seed substrate on which a second piece formed of the second photonic stack rests;
c23) a step of assembling the second pieces on the coupling face;
c24) a step of removing the second portion at the end of step c23) so as to transfer the second piece onto the coupling face.

According to one embodiment, the step b) comprises the following sub-steps:
b21) a step of forming, by epitaxy, the second photonic stack on one face, called the seed face, of a second seed substrate;
b22) a cutting step to form second sections that each comprise a second portion of the second seed substrate on which a second piece formed of the second photonic stack rests;
b23) a step of assembling the second pieces on the coupling face;
b24) a step of removing the second portion at the end of step c23) so as to transfer the second piece onto the coupling face.

According to one embodiment, the first and the second photonic stack each comprise a stack of quantum wells interposed between a lower layer and an upper layer, the lower layer resting on the coupling layer.

According to one embodiment, the first photonic stack and the second photonic stack are formed by epitaxy before being transferred to the coupling face.

According to one embodiment, the at least one first photonic component comprises a laser.

According to one embodiment, the at least one second photonic component comprises an avalanche photodiode, advantageously, the interface formed between the second photonic stack and the coupling layer is devoid of an anti-reflective layer.

According to one embodiment, a reflective element is formed in the coupling layer, and is arranged so that the first grating coupler is interposed between the reflective element and the at least one second photonic component.

According to one embodiment, the second waveguide is also terminated at its other end by a second grating coupler, and the second grating coupler being arranged to allow the injection of light radiation into the second waveguide from the coupling face.

According to one embodiment, another reflective element is formed in the coupling layer, and is arranged so that the second grating coupler is interposed between the reflective element and the coupling face.

The present disclosure also relates to a photonic device that comprises:
a final substrate provided with a main face;
a coupling layer provided with a coupling face and an assembly face, opposite the coupling face, the coupling layer resting, by its assembly face, on the main face of the final substrate, the coupling layer comprising at least one first waveguide and at least one second waveguide, terminated on one of its ends by a first grating coupler, the first waveguide comprising a monocrystalline material, the first waveguide and the second waveguide being remote from the coupling face, respectively, a first distance D1 and a second distance D2, greater than the first distance D1, advantageously the first distance D1 is less than 150 nm and the second distance D2 is greater than 200 nm;
a first and a second photonic component formed respectively of a first and a second photonic stack, the first and the second photonic component being optically coupled, respectively, with the at least one first waveguide evanescently or adiabatically, and with the at least one second waveguide via the first grating coupler.

According to one embodiment, the second photonic component comprises an avalanche photodiode; advantageously, the interface formed between the second photonic stack and the coupling layer is devoid of an anti-reflective layer.

According to one embodiment, the second waveguide is also terminated at its other end by a second grating coupler, and the second grating coupler being arranged to allow the injection of light radiation into the second waveguide from the coupling face.

According to one embodiment, the device further comprises a reflective element formed in the coupling layer, and arranged so that the first grating coupler is interposed between the reflective element and the at least one second photonic component.

### BRIEF DESCRIPTION OF THE DRAWINGS

Other features and advantages of the present disclosure will emerge from the following detailed description of embodiments of the present disclosure with reference to the appended figures, in which:

FIG. 1, drawn from the document [1] cited at the end of the description, is an illustration, in perspective, of the surface coupling of a photodetector with a waveguide terminated by a first grating coupler;

FIG. 2, drawn from the document [2] cited at the end of the description, is an illustration, in perspective, of the evanescent or adiabatic wave coupling of an avalanche photodiode with a waveguide;

FIG. 3 repeats FIG. 2(a) of the document [3] cited at the end of the description, this figure in particular represents, in a perspective view, a butt coupling between a photonic device and a waveguide, known from the prior art;

FIG. 4 is a schematic representation, along a sectional plane perpendicular to the main face, of a support structure provided during step a) of the method according to the present disclosure;

FIG. 5 is a schematic representation of the support structure of FIG. 4 according to another sectional plane perpendicular to the main face and that comprises an elongation axis of the second waveguide, FIG. 5 in particular makes it possible to show the grating couplers terminating the second waveguide according to each of its ends;

FIG. 6 is a schematic representation of a semiconductor-on-insulator substrate capable of being implemented for the formation of the coupling layer;

FIG. 7 is a schematic representation of the sub-step a1) of forming a first waveguide on the semiconductor-on-insulator substrate of FIG. 6;

FIG. 8 is a schematic representation of the sub-step a2) of forming a first layer overlapping the front face of the semiconductor-on-insulator substrate and intended to encapsulate the first waveguide;

FIG. 9 is a schematic representation of the sub-step a3) of forming the second waveguide and the first grating coupler on the first sheath layer;

FIG. 10A is a schematic representation of the sub-step a4) of forming a second layer overlapping the first sheath layer and intended to encapsulate the second waveguide and the first grating coupler;

FIG. 10B is a schematic representation of the sub-step a4) of forming a second layer overlapping the first sheath layer and intended to encapsulate the second waveguide and the first grating coupler, step a4) in the context of this representation also comprises the formation of the two reflective elements;

FIG. 11 is a schematic representation of a step of assembling the assembly face of the coupling layer with the main face of the final substrate;

FIG. 12 is a schematic representation of a step of removing the initial substrate after execution of the assembling shown in FIG. 11, so as to transfer the coupling layer onto the main face of the final substrate;

FIG. 13 is a schematic representation of a step of transferring a first block and a second block onto the coupling face;

FIG. 14 is a photograph, from the coupling face, of first blocks and of second blocks transferred to the coupling face;

FIG. 15 is a schematic representation along a sectional plane perpendicular to the main face, of the support structure on which the first photonic component and the second photonic component are formed at the end of the execution of step c);

FIG. 16 is a schematic representation along a sectional plane along a sectional plane perpendicular to the main face, of the support structure on which the first photonic component and the second component are formed, the first photonic component and the second photonic component being encapsulated by an encapsulation layer;

FIG. 17 is a schematic representation along a sectional plane perpendicular to the main face, and on which electrical contacts enabling the electrical control of the first photonic component and of the second photonic component are shown;

FIG. 18 is a schematic representation showing the coupling between the second photonic component and the first grating coupler; and

FIG. 19 is a schematic representation of the first photonic component in adiabatic/evanescent coupling along a sectional plane parallel to the plane (0, y, z).

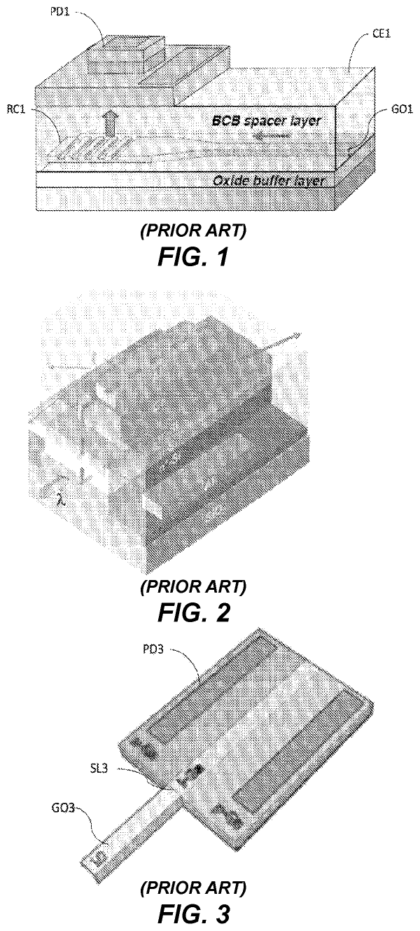

### DETAILED DESCRIPTION

This present disclosure relates to a method for manufacturing a photonic device. In particular, the method according to the present disclosure makes it possible to consider integrating, within the same photonic device, a plurality of photonic components coupled to the device in different ways.

In particular, the present disclosure makes it possible to integrate, within a photonic device, a first photonic component, coupled to the device evanescently or adiabatically, and a second photonic component coupled to the device by means of a grating coupler.

To this end, the method according to the present disclosure comprises the following successive steps:
a) a step of providing a support structure that comprises a coupling layer provided with a coupling face and an assembly face, opposite the coupling face, the coupling layer resting, by its assembly face, on a main face of a final substrate, the coupling layer comprising at least one first waveguide and at least one second waveguide, terminated on one of its ends by a grating coupler, the first waveguide and the grating coupler comprising a monocrystalline material, the first and the second waveguide being remote from the coupling face, respectively, a first distance D1 and a second distance D2, greater than the first distance D1, the provision of the support structure comprising the formation of the coupling layer from a semiconductor-on-insulator substrate, then the transfer of the coupling layer onto the main face of the final substrate;
b) a step of transferring, onto the coupling face, at least a first and at least a second block made, respectively, of a first and a second photonic stack;
c) a step of forming from the first block and from the second block, respectively, a first and a second photonic component optically coupled, respectively, with the at least one first waveguide evanescently or adiabatically, and with the at least one second waveguide via the grating coupler.

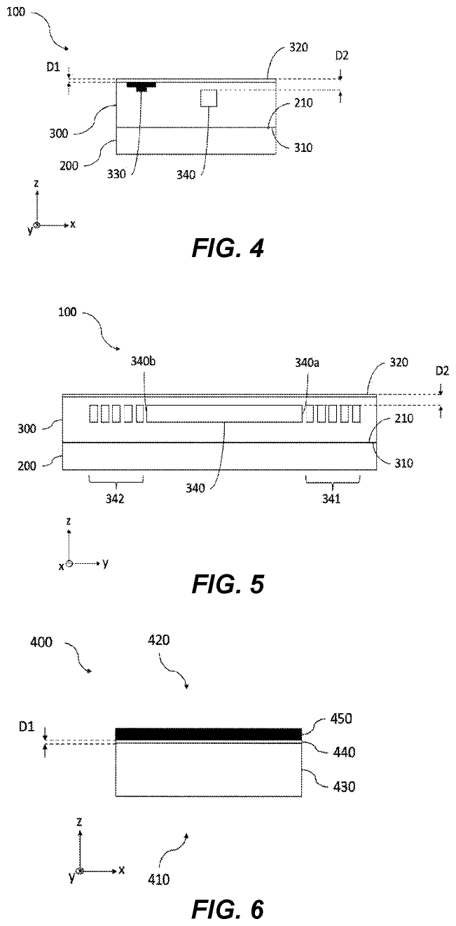

Thus, FIG. 4 shows, in an orthonormal reference frame (x, y, z), a support structure provided during the execution of step a).

In particular, the support structure comprises a final substrate 200 provided with a main face 210 on which, via its assembly face 310, a coupling layer 300 rests. The coupling layer 300 also comprises a coupling face 320, opposite the assembly face 310.

In the description, and unless otherwise specified, the faces and the layers extend parallel to the plane (x, y) and are therefore perpendicular to the direction z.

The final substrate 200 may comprise any type of material. In particular, the final substrate 200 may comprise a semiconductor material. In this respect, the semiconductor material may comprise silicon, aluminum nitride, germanium, or a silicon germanium alloy.

Alternatively, the final substrate 200 may comprise an insulating material. For example, the insulating material may comprise glass.

The coupling layer 300 comprises at least a first waveguide 330 and at least a second waveguide 340. In particular, the first waveguide 330 is remote from the coupling face 320 by a first distance D1. In an equivalent manner, the second waveguide 340 is remote from the coupling face 320 by a second distance D2 greater than the first distance D1 (FIG. 4 and FIG. 5).

It is understood that the first waveguide 330 and the second waveguide 340 each extend in a plane parallel to the plane (x, y), and therefore remain at a constant distance from the coupling face 320.

It is also understood that the first waveguide 330 and the second waveguide 340 do not necessarily extend in the same directions.

The second waveguide 340 is terminated at one of its ends 340a by a first optical grating coupler 341 (FIG. 5). The first optical grating coupler 341 can be made of the same material as the first waveguide 330. It is also understood, without it being necessary to specify it, that the first grating coupler 341 is also remote from the coupling face 320 of the second distance D2.

Equivalently, the second waveguide 340 may be terminated on another of its ends 340b by a second optical grating coupler 342 (FIG. 5). The second optical grating coupler 342 can be made of the same material as the second waveguide 340. It is also understood, without it being necessary to specify it, that the second grating coupler 342 is also remote from the coupling face 320 of the second distance D2. Alternatively, the second waveguide by being terminated on its other end for a coupler by the edge face. In the context of the present disclosure, the edge face is defined as a contour connecting the assembly face and the coupling face.

Also, and throughout the disclosure of the present disclosure, the mere mention of a second waveguide 340 refers to the second waveguide but also to the first grating coupler as well as to the second grating coupler if the latter is considered.

The first waveguide 330 comprises a monocrystalline material, and more particularly monocrystalline silicon.

Advantageously, the second waveguide 340 may comprise silicon nitride. However, the present disclosure is not limited to the implementation of this material alone.

Step a) of providing the support structure comprises:
forming the coupling layer 300 from a semiconductor-on-insulator substrate 400; and
transferring the coupling layer 300 onto the main face 210 of the final substrate 200.

As shown in FIG. 6, the semiconductor-on-insulator substrate 400 comprises, from a rear face 410 toward a front face 420, an initial substrate 430, a buried oxide layer 440 and a semiconductor layer 450. The semiconductor layer comprises a monocrystalline material.

It will appear clearly hereinafter that the buried oxide layer 440 is intended to form, at least in part, the coupling layer 300.

Furthermore, the buried oxide layer 440 may advantageously have a thickness equal to the first distance D1.

The initial substrate 430 may comprise a semiconductor material, an insulating material, or a conductive material.

In particular, the initial substrate 430 may comprise silicon.

The buried oxide layer 440 may comprise silicon dioxide.

The semiconductor layer 450 may comprise silicon.

However, the present disclosure must not be limited to these materials alone, and the person skilled in the art, depending on the intended applications, may implement any other material that may be suitable.

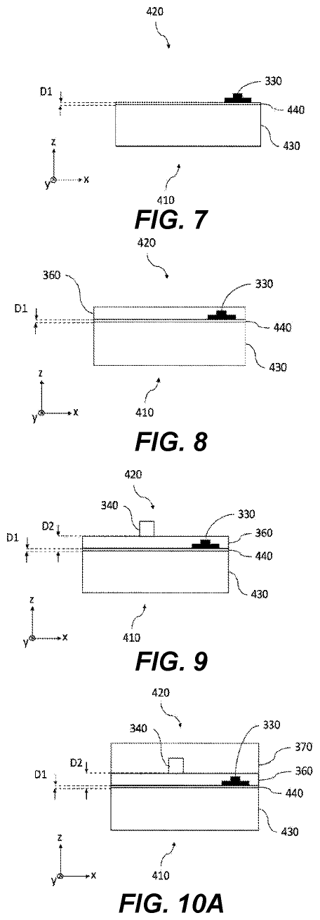

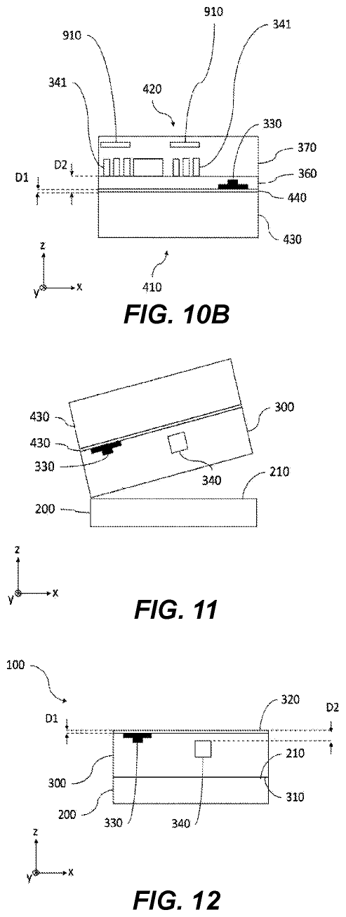

The formation of the coupling layer 300 from the semiconductor-on-insulator substrate 400 may comprise the following sub-steps:
a sub-step a1) of partial etching of the semiconductor layer 450 so as to form the at least one first waveguide 330 (FIG. 7);
a sub-step a2) of forming a first sheath layer 360 by overlapping the front face 420 of the semiconductor-on-insulator substrate 400 and intended to encapsulate the first waveguide 330 (FIG. 8), the first sheath layer may, for example, comprise SiO₂;
a sub-step a3) of forming the second waveguide 340 and of the first grating coupler 341 (and of the second grating coupler 342 if considered) on the first sheath layer 360 (FIG. 9);
a sub-step a4) of forming a second sheath layer 370 overlapping the first sheath layer 360 and intended to encapsulate the second waveguide 340 and the first grating coupler 341 (FIG. 10A). The second sheath layer 370 may, for example, comprise SiO₂.

The sub-step a1) can implement a combination of steps of photolithography and etching. In particular, a photolithography step makes it possible to define a pattern, and more particularly the pattern associated with the first waveguide 330 on the semiconductor layer 450, while an etching step makes it possible to form the first waveguide 330 from the pattern defined during the photolithography step. These aspects, well known to the person skilled in the art, are not detailed in the present disclosure.

The formation of the first sheath layer 360 during the execution of sub-step a2) can implement a technique for depositing layers. In particular, the first sheath layer 360 can be deposited by a chemical vapor deposition (“CVD”) technique and more particularly a low-pressure chemical vapor deposition (“LPCVD”) technique, or a plasma-enhanced chemical vapor deposition (“PECVD”) technique. Alternatively, the first sheath layer 360 can be deposited by a physical vapor deposition (PVD) technique.

Finally, this sub-step a2) can also implement polishing (in particular chemical mechanical polishing) intended to adjust the thickness of the first sheath layer 360.

The first sheath layer 360 may comprise silicon dioxide.

The formation of the second waveguide 340, during the execution of sub-step a3), can implement a combination of steps of layer deposition, photolithography and etching.

In particular, the formation of the second waveguide 340 may, initially, comprise the formation of a guide layer overlapping the first sheath layer 360. The guide layer may be deposited by a vapor deposition technique and more particularly a low-pressure vapor deposition technique, or a plasma-activated vapor phase deposition technique. Alternatively, the guide layer may be deposited by a physical vapor deposition technique. The guide layer advantageously comprises silicon nitride.

A photolithography step is then executed in order to define a pattern, and more particularly the pattern of the second waveguide 340 on the guide layer. Finally, the implementation of an etching step makes it possible to form the second waveguide 340 from the pattern defined during the photolithography step. These aspects, well known to the person skilled in the art, are not detailed in the present disclosure.

It is also understood that the execution of sub-step a3) also leads to the formation of the first grating coupler 341 and of the second grating coupler 342 from the guide layer. In other words, the second waveguide 340, the first grating coupler 341 and the second grating coupler 342 rest on the first sheath layer 360 and are made of the same material.

Finally, the formation of the second sheath layer 370 during the execution of sub-step a4) can implement a technique for depositing layers. In particular, the second sheath layer may be deposited by a vapor deposition technique and more particularly a low-pressure vapor deposition technique, or a plasma-activated vapor phase deposition technique. Alternatively, the second sheath layer 370 may be deposited by a physical vapor deposition technique.

Finally, this sub-step a4) can also implement polishing (in particular chemical mechanical polishing) intended to adjust the thickness of the second sheath layer 370.

The second sheath layer 370 may comprise silicon dioxide.

The coupling layer 300 is thus obtained at the end of the execution of the sub-steps a1) to a4). The coupling layer 300 comprises, in particular, from its coupling face to its assembly face, the buried oxide layer 440, the first sheath layer 360 and the second sheath layer 370. The coupling layer 300 also comprises the first waveguide 330 and the second waveguide 340. In particular, the first waveguide 330 is interposed between the buried oxide layer 440 and the first sheath layer 360, while the second waveguide 340 is between the first sheath layer 360 and the second sheath layer 370.

The thickness of the buried oxide layer 440 and that of the first sheath layer 360 make it possible to adjust the first distance D1 and the second distance D2.

The coupling layer 300 resting on the initial substrate can thus be transferred onto a main face 210 of the final substrate 200.

This transfer comprises, in particular, an assembling of an assembly face of the coupling layer 300 with the main face 210 of the final substrate 200 (FIG. 11). The assembly can, in particular, comprise, without however limiting the present disclosure to this aspect alone, molecular bonding.

The assembly can be followed by a step of removing the initial substrate 430 so as to transfer the coupling layer 300 onto the main face 210 (FIG. 12). The removal of the initial substrate 430 may comprise a mechanical thinning, a chemical attack or a combination of both.

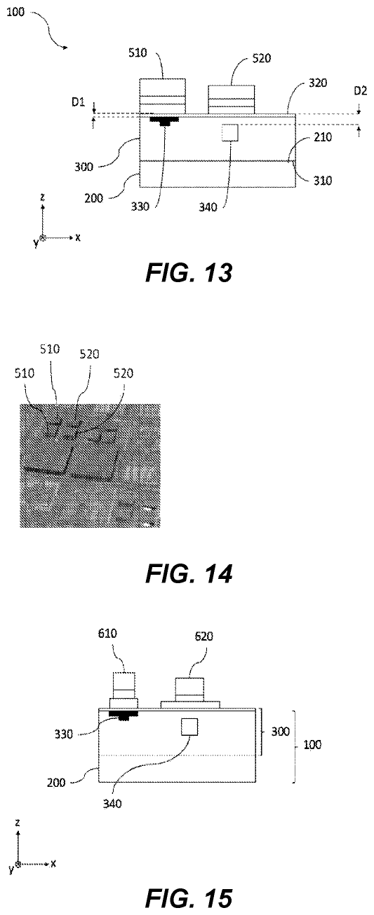

The method according to the present disclosure also comprises a step b) of transferring (by assembly and, more particularly, by bonding), on the coupling face, at least one first block 510 and at least one second block 520 made, respectively, of a first photonic stack and a second photonic stack (FIG. 13).

“Photonic stack” is understood to mean a stack of layers of materials, in particular layers of semiconductor materials, capable of emitting light radiation once it is subjected to an electrical signal, or emits an electrical signal once it absorbs light radiation.

It is also understood, according to the terms of the present disclosure, that as soon as a photonic stack is transferred onto the coupling face, the layers of material forming it are stacked in the direction z.

According to the present disclosure, the first block 510 and the second block 520 each form a piece that can be transferred by a pick-and-place method and bonding. FIG. 14, which shows pieces (first block or second block), is an illustration thereof.

The formation of the first block 510 and of the second block 520 may involve epitaxy steps, and in particular epitaxy steps on a substrate, called a seed substrate.

In particular, the formation of the first block 510 on the coupling face may comprise the following steps:
b11) a step of forming, by epitaxy, the first photonic stack on one face, called the seed face, of a first seed substrate;
b12) a cutting step to form first sections that each comprise a first portion of the first seed substrate on which a first piece formed of the first photonic stack rests;
b13) a step of assembling the first pieces on the coupling face;
b14) a step of removing the first portion at the end of step b13) so as to transfer the first piece onto the coupling face.

In an equivalent manner, the formation of the second stack on the coupling face may comprise the following steps:
b21) a step of forming, by epitaxy, the second photonic stack on one face, called the seed face, of a second seed substrate;
b22) a cutting step to form second sections that each comprise a second portion of the second seed substrate on which a second piece formed of the second photonic stack rests;
b23) a step of assembling the second pieces on the coupling face;
b24) a step of removing the second portion at the end of step c23) so as to transfer the second piece onto the coupling face.

The method according to the present disclosure also comprises a step c) of forming from the first block 510 and from the second block 520, respectively, a first 610 and a second 620 photonic component. Step c) may in particular comprise a sequence of photolithography and etching steps intended to form the first photonic component and the second photonic component.

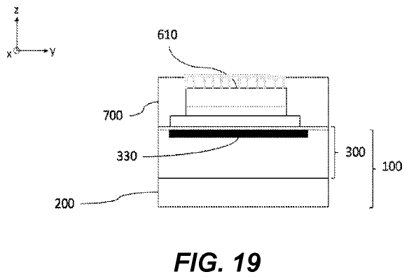

Thus, at the end of step c), the first photonic component 610 is optically coupled with the first waveguide 330 according to an evanescent or adiabatic wave coupling mode (FIGS. 15, 19). In other words, light radiation guided by the first waveguide is capable of being transferred to the first photonic component 610. It is understood that such an optical coupling, by evanescent or adiabatic waves, is obtained as soon as the first photonic component is in proximity D1 of the first waveguide 330 and that the waveguides have close indices. In other words, the step b) of transferring the first block and step c) are executed so that the first optical component 610 is arranged plumb with a section of the first waveguide 330.

In an equivalent manner, at the end of step c), the second photonic component 620 is optically coupled with the second waveguide 340 via the first grating coupler 341 (FIG. 15 and FIG. 18). In other words, a light radiation guided by the second waveguide 340 is capable of being transferred to the second photonic component 620 via the first grating coupler. Thus, the step b) of transferring the second block and step c) are executed so that the second optical component 620 is arranged plumb with the first grating coupler 341.

Thus, as shown in FIG. 18, light radiation RI incident by the front face and plumb with the second grating coupler 342 is transmitted to the second grating coupler 342 in order to then be guided by the second waveguide from the end 340b to the end 340a and reach the first grating coupler 341. As soon as it reaches the first grating coupler 341, the radiation is directed toward the face, called the lower face, of the second optical component, in contact with the coupling face 320.

The lower face may nevertheless have a non-zero reflectivity coefficient, so that the radiation directed toward the face is partially reflected thereby.

Also, the light radiation RI, during its interaction with the second grating coupler 342, may, in part, pass through the latter without being guided in the direction of the second waveguide 340.

These undesired effects directly affect the efficiency of the optical coupling(s).

The consideration of antireflective layers in order to overcome these undesirable effects is, however, neither desirable nor easy to implement.

Thus, and as shown in FIG. 18, it is possible to provide the formation of two reflective elements 910 and 920 so as to improve the optical efficiency of the device.

In particular, the reflective element 910 is formed in the coupling layer 300, and is arranged so that the first grating coupler is interposed between the reflective element 910 and the at least one second photonic component 620.

In an equivalent manner, the reflective element 920 is formed in the coupling layer 300, and is arranged so that the second grating coupler is interposed between the reflective element 920 and the coupling face.

The reflective elements 910 and 920 may each comprise a Bragg mirror, and be formed during the execution of sub-step a2).

This arrangement is particularly advantageous since it does not require implementing an anti-reflective layer overlapping the optically active face (the lower face) of the second photonic component. Indeed, in the example shown in FIG. 18, the reflective element 910 makes it possible to return to the lower face of the second photonic component 620 the radiation portion reflected by the face.

Equivalently, the light radiation partially passing through the second grating coupler 342 can be reinjected into the grating by being reflected on the reflective element 920.

As shown in FIG. 10B, the reflective elements 910 and 920 can be formed during step a4) of forming the second sheath layer 370. In particular, step a4) can comprise:
forming a first section of the second sheath layer overlapping the first sheath layer and the first waveguide;
forming the two reflectors 910 and 920 on the first section of the second sheath layer;
forming a second section of the second sheath layer overlapping the two reflectors and the first section of the second sheath layer.

As an example, the first photonic component may comprise a laser, and in particular a laser based on InP. The photonic stack making it possible to form an InP-based laser comprises in particular a P-doped InP layer and an N-doped InP layer, between which a set of quantum wells is interposed.

The evanescent or adiabatic wave coupling of a first waveguide, made of, for example, monocrystalline silicon, and in the vicinity of the first photonic component is relatively effective. The proximity of the refractive indices, in the wavelength range between 1310 nm and 1550 nm, of single-crystal silicon forming the first waveguide and the InP forming the first photonic component, as well as the proximity (distance D1 less than or equal to 150 nm) of these two elements makes coupling by evanescent waves or adiabatic waves particularly effective.

The second photonic component may comprise an avalanche photodiode. In particular, the avalanche photodiode can adopt the same terms as the photodiode presented in the document [4] cited at the end of the description.

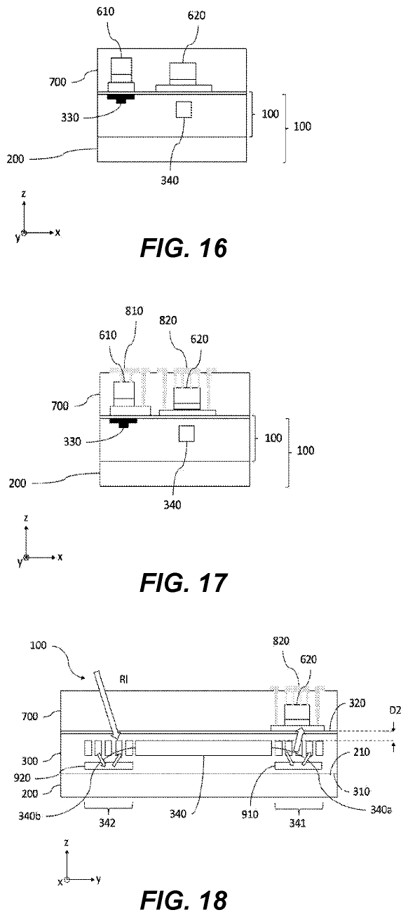

An encapsulation layer 700 overlapping the first photonic component 610 and the second photonic component 620 can be formed (FIG. 16). The encapsulation layer 700 may comprise an insulating material, and in particular silicon dioxide. The formation of the encapsulation layer 700 is within the scope of the person skilled in the art, and is therefore not described in the present description.

The formation of the encapsulation layer 700 can be followed by the formation of first contacts 810, associated with the first photonic component 610, and of second contacts 820 associated with the second photonic component 620 (FIG. 17). The first 810 and the second 820 contacts are in particular intended to allow the electrical control, respectively, of the first photonic component 610 and of the second photonic component 620.

The formation of the contacts 810 and 820 is within the scope of the person skilled in the art, and is therefore not described in the present description.

In particular, the method, as described above, enables different waveguides to be buried at different depths. This configuration is particularly advantageous as soon as optical components requiring different optical couplings must be integrated into the same device.

Particularly advantageously, the coupling layer 300 is formed so that the first distance D1 is less than or equal to 150 nm (and not zero). Such a distance makes it possible to establish an evanescent or adiabatic wave coupling between the first waveguide and the first optical component.

Also particularly advantageously, the coupling layer 300 is formed so that the second distance D2 is greater than 200 nm. Such a distance makes it possible to establish a coupling between the second waveguide and the second photonic component via the grating coupler while limiting (or even preventing) evanescent or adiabatic wave coupling.

The implementation of reflective elements 910 and 920 makes it possible to improve the efficiency of the optical coupling between the second waveguide and the second photonic component, in particular without having to use antireflective layers on the lower face of the second photonic component.

Finally, the method according to the present disclosure makes it possible to consider a first waveguide made of a monocrystalline semiconductor material at a distance D1 from the coupling face less than the distance D2 to which the second waveguide is located.

The present disclosure also relates to a photonic device that largely comprises the features presented above.

In particular, the photonic device comprises:
a final substrate provided with a main face;
a coupling layer provided with a coupling face and an assembly face, opposite the coupling face, the coupling layer resting, by its assembly face, on the main face of the final substrate, the coupling layer comprising at least one first waveguide and at least one second waveguide, terminated on one of its ends by a first grating coupler, the first waveguide and the second waveguide being remote from the coupling face, respectively, a first distance D1 and a second distance D2, greater than the first distance D1, the first waveguide and the first grating coupler comprising a monocrystalline material, advantageously the first distance D1 is less than 150 nm and the second distance D2 is greater than 200 nm;
a first and a second photonic component formed respectively of a first and a second photonic stack, the first and the second photonic component being optically coupled, respectively, with the at least one first waveguide evanescently or adiabatically, and with the at least one second waveguide via the first grating coupler.

Advantageously, the second photonic component comprises an avalanche photodiode, advantageously, the interface formed between the second photonic stack and the coupling layer is devoid of an anti-reflective layer.

Also advantageously, the second waveguide is also terminated at its other end by a second grating coupler or a coupler by the edge face, and the second grating coupler being arranged to allow the injection of light radiation into the second waveguide from the coupling face.

Also advantageously, the device further comprises a reflective element formed in the coupling layer, and arranged so that the first grating coupler is interposed between the reflective element and the at least one second photonic component.

Of course, the present disclosure is not limited to the described embodiments and variant embodiments may be envisaged without departing from the scope of the invention as defined by the claims.

### REFERENCES

[1] G. Roelkens, J. Brouckaert, D. Taillaert, P. Dumon, W. Bogaerts, D. Van Thourhout, R. Baets, R. Nôtzel, and M. Smit, “Intégration of InP/InGaAsP photodetectors onto silicon-on-insulator waveguide circuits,” Opt. Express 13, 10102-10108 (2005);
[2] Zhihong Huang, Cheng Li, Di Liang, Kunzhi Yu, Charles Santori, Marco Fiorentino, Wayne Sorin, Samuel Palermo, and Raymond G. Beausoleil, “25 Gbps low-voltage waveguide Si-Ge avalanche photodiode,” Optica 3, 793-798 (2016);
[3] L. Vivien, et al., “Zero-bias 40 Gbit/s germanium waveguide photodetector on Silicon,” Optics Express, vol. 20. (2), November 2011;
[4] Liu, J. -J. et al., “The Fabrication and Characterization of InAlAs/InGaAs APDs Based on Mesa-Structure with Polyimide Passivation,” Sensors 2019, 19, 3399;
[5] EP3764136A1;
[6] US2004/081399A1.

1. A method of manufacturing a photonic device comprising the following successive steps:
a) a step of providing a support structure comprising a coupling layer having a coupling face and an assembly face, opposite the coupling face, the coupling layer having an assembly face disposed on a main face of a final substrate, the coupling layer comprising at least one first waveguide and at least one second waveguide, the at least one second waveguide terminated on an end thereof by a first grating coupler, the first waveguide comprising a monocrystalline material, the at least one first waveguide being remote from the coupling face by a first distance D1, the at least one second waveguide being remote from the coupling face by a second distance D2 greater than the first distance D1, the providing of the support structure comprising forming the coupling layer from a semiconductor-on-insulator substrate, and transferring the coupling layer onto the main face of the final substrate;
b) a step of transferring, onto the coupling face of the coupling layer, at least a first block including a first photonic stack and at least a second block including a second photonic stack; and
c) a step of forming from the first block a first photonic component evanescently or adiabatically optically coupled with the at least one first waveguide, and forming from the second block a second photonic component optically coupled with the at least one second waveguide via the grating coupler

2. The method of claim 1, wherein the semiconductor-on-insulator substrate comprises, from a rear face toward a front face thereof, an initial substrate, a buried oxide layer and a semiconductor layer, the buried oxide layer forming part of the coupling layer, and advantageously having a thickness equal to the first distance D1.

3. The method of claim 2, wherein the forming of the coupling layer comprises a sub-step a1) of partial etching of the semiconductor layer so as to form the at least one first waveguide.

4. The method of claim 3, wherein the forming of the coupling layer comprises a sub-step a2) of forming a first sheath layer overlapping the front face of the semiconductor-on-insulator substrate.

5. The method of claim 4, wherein the forming of the coupling layer comprises a sub-step a3) of forming the second waveguide and the first grating coupler on the first sheath layer.

6. The method of claim 5, wherein the forming of the coupling layer comprises a sub-step a4) of forming a second sheath layer overlapping the first sheath layer.

7. The method of claim 1, further comprising forming the first photonic stack and the second photonic stack by epitaxy before the transferring of the first block and the second block to the coupling face.

8. The method of claim 1, wherein the at least one first photonic component comprises a laser.

9. The method of claim 1, wherein the at least one second photonic component comprises an avalanche photodiode.

10. The method of claim 1, further comprising forming a reflective element in the coupling layer, the reflective element arranged so that the first grating coupler is interposed between the reflective element and the at least one second photonic component.

11. The method of claim 1, wherein the second waveguide is terminated at another end thereof by a second grating coupler, the second grating coupler being arranged to allow the injection of light radiation into the second waveguide from the coupling face.

12. A photonic device that comprises, comprising:
a final substrate having a main face;
a coupling layer provided with having a coupling face and an assembly face, opposite the coupling face, the assembly face of the coupling layer disposed on the main face of the final substrate, the coupling layer comprising at least one first waveguide and at least one second waveguide, an end of the at least one second waveguide terminated by a first grating coupler, the first waveguide comprising a semiconductor monocrystalline material, the first waveguide being remote from the coupling face by a first distance D1, the second waveguide being remote from the coupling face by a second distance D2, the second distance D2 being greater than the first distance D1; and
a first photonic component formed of a first photonic stack, and a second photonic component formed of a second photonic stack, the first photonic component being evanescently or adiabatically optically coupled with the at least one first waveguide, the second photonic component being optically coupled with the at least one second waveguide via the first grating coupler.

13. The photonic device of claim 12, wherein the second photonic component comprises an avalanche photodiode.

14. The photonic device of claim 12, wherein the second waveguide is terminated on another end thereof by a second coupling network, the second coupling network being arranged to allow injection of light radiation into the second waveguide from the coupling face.

15. The photonic device of claim 12, wherein the second waveguide is terminated on another end thereof by a coupler by an edge face, the edge face being an outline of the coupling layer connecting the coupling face and the assembly face.

16. The photonic device of claim 12, further comprising a reflective element in the coupling layer, the reflective element arranged so that the first grating coupler is interposed between the reflective element and the at least one second photonic component.

17. The device of claim 12, wherein the first distance D1 is less than 150 nm and the second distance D2 is greater than 200 nm.

18. The method of claim 1, wherein the first distance D1 is less than 150 nm and the second distance D2 is greater than 200 nm.

19. The method of claim 2, wherein the buried oxide layer has a thickness equal to the first distance D1.

20. The method of claim 4, wherein the first sheath layer comprises silicon dioxide, the method further comprising encapsulating the first waveguide with the first sheath layer.
